(19) United States
(12) Patent Application Publication
(10) Pub. No.: US 2006/0018280 A1
(43) Pub. Date: Jan. 26, 2006

(54) System and associated mobile node, foreign agent and method for link-layer assisted mobile IP fast handoff from a fast-access network to a slow-access network

(75) Inventors: Krishna Kumar, San Diego, CA (US); Jianhao Michael Yang, San Diego, CA (US); Sarvesh Asthana, San Diego, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/895,219

(22) Filed: Jul. 20, 2004

(51) Int. Cl. H04Q 7/00; H04J 3/16

(52) U.S. Cl. 370/331; 370/469

(57) ABSTRACT

A system for handing off a mobile node includes a mobile node and a target agent. The mobile node can communicate with an anchor agent, and can also be handed off from the anchor agent. The mobile node can establish a physical-layer connection between the mobile node and a target base station associated with the target agent. Also, the target agent can establish a tunnel between the target agent and the anchor agent. Thereafter, the mobile node can establish a link-layer connection between the mobile node and the target agent via the anchor agent and the tunnel. Then, the mobile node can register with the target agent to thereby bind the mobile node to the target agent such that data packet(s) pass through the target agent, across the link-layer connection and the physical-layer connection, and independent of the anchor agent and the tunnel.

### FIELD OF THE INVENTION

The present invention generally relates to systems and methods of handing off a mobile node from one router to another and, more particularly, relates to systems and methods of link-layer assisted fast handoff of a mobile node from one router in a fast-access network to another router in a slow-access network.

### BACKGROUND OF THE INVENTION

The mobile Internet Protocol (IP) enables a mobile terminal to move freely from one point of connection to another in various networks it visits along its route. In particular, the MIP protocol describes those actions that enable a mobile terminal to maintain connectivity during a handover from one access router to another access router. A typical handover of the mobile terminal, however, requires link-layer and IP-layer signaling. And during this signaling phase, the mobile terminal is unable to send or receive data packets. This time period is referred to as handoff delay. In many situations, the handoff delay may be unacceptable to support real-time, or otherwise delay sensitive network traffic. Thus, seamless mobility management techniques can be required for such services. In this regard, seamless mobility management can reduce or eliminate service interruption, packet loss and handoff delay, thus increasing the quality of service (QoS).

As will be appreciated, seamless handoff can be achieved through fast handoff and context transfer. Generic fast handoff mechanisms, however, only reduce the IP-layer signaling delays and do not address the link-layer delays. In this regard, there is currently no standardized technique to reduce the handoff delay when a mobile terminal moves from one link-layer technology to another. For example, a mobile terminal moving from a wireless local area network (WLAN) to a CDMA network still experiences latency due to physical-layer and link-layer signalling during handoff from one network to the other.

As will also be appreciated, different networks can be categorized as either fast-access networks (e.g., WLAN, WiMAX, Bluetooth, etc.) or slow-access networks (e.g., CDMA, GPRS, 1XEV-DO, etc.). Thus, when a mobile terminal roams from one network to another, four possibilities exist with respect to the access speed of the networks, namely, the mobile terminal can roam (1) from a fast-access network to another fast-access network, (2) from a slow-access network to a fast-access network, (3) from a fast-access network to a slow-access network, or (4) from a slow-access network to another slow-access network. And within roaming from a slow-access network to another slow-access network, the mobile terminal can more particularly roam (a) from one slow-access network to another of the same type of slow-access network (e.g., inter-PDSN handoff for a CDMA network), or (b) from a slow-access network to another, different type of slow-access network (e.g., from CDMA to GPRS).

Link-layer delay during MIP fast handoff is generally not a concern for mobile terminals roaming from a fast-access network to another fast-access network, or from a slow-access network to a fast-access network, since the link-layer setup for such handoffs is typically very fast (e.g., up to several hundred milliseconds). However, for mobile terminals roaming from a fast-access network to a slow-access network, or a slow-access network to another slow-access network, link-layer assistance can be beneficial to eliminate or at least decrease the delay due to link-layer set up.

### SUMMARY OF THE INVENTION

In light of the foregoing background, embodiments of the present invention provide an improved system and associated mobile node, agent and method for link-layer assisted fast handoff from one point of connection to another in various networks the terminal visits along its route. Embodiments of the present invention are capable of handing off a terminal from one point of connection to another, while reducing link-layer delay otherwise associated with such handoff. More particularly, embodiments of the present invention are capable of reducing link-layer delay when a mobile terminal is handed off from a fast-access network to a slow-access network.

According to one aspect of the present invention, a system is provided for handing off a mobile node. The system includes a mobile node and a target agent (e.g., target home or foreign agent), and can also include a correspondent node. The mobile node is capable of communicating with an anchor agent (e.g., target home or foreign agent), and also capable of being handed off from the anchor agent. To effectuate the handoff, the mobile node is capable of establishing a physical-layer connection between the mobile node and a target base station associated with the target agent. The target agent is capable of establishing a tunnel between the target agent and the anchor agent. Thereafter, the mobile node is capable of establishing a link-layer connection between the mobile node and the target agent via the anchor agent and the tunnel between the anchor agent and the target agent. By establishing the tunnel between an anchor agent in a fast-access network and a target agent in a slow-access network, and establishing the link-layer connection via the anchor agent and the tunnel, the system is capable of reducing delay in establishing a link-layer connection with the target agent.

After the link-layer connection is established, the mobile node is capable of registering with the target agent to thereby bind the mobile node to the target agent such that data packet(s) sent between the mobile node and a correspondent node pass through the target agent, across the link-layer connection and the physical-layer connection, and independent of the anchor agent and the tunnel. More particularly, after the mobile node registers with the target agent, the target agent can be capable of receiving an incoming data packet from the correspondent node independent of the anchor agent. The target agent can then be capable of activating a link-layer context negotiated during establishment of the link-layer connection, and thereafter forwarding the data packet to the mobile node from the target agent. Similarly, the target agent can be capable of receiving an outgoing data packet from the mobile node. The target agent can then be capable of forwarding the data packet to the correspondent node independent of the anchor agent and the tunnel, and in accordance with the previously negotiated link-layer context.

The mobile node can be capable of establishing the link-layer connection before completing establishment of the physical-layer connection. In such instances, the mobile node can also be capable of the physical-layer connection independent of the anchor agent and the tunnel. Alternatively, the mobile node can be capable of establishing the physical-layer connection via the anchor agent, the tunnel between the anchor agent and the target agent, and an interface with the target base station. More particularly, in such instances the mobile node can be capable of receiving at least one network parameter for a network (e.g., slow-access network) including the target agent, and thereafter establish a connection with the anchor agent to thereby communicate with the anchor agent. The mobile node can then be capable of establishing the physical-layer connection via an interface previously established based upon the at least one network parameter.

According to other aspects of the present invention, a mobile node, agent and method are provided for handing off the mobile node. Embodiments of the present invention therefore provide an improved system and associated mobile node, agent and method for handing off a mobile node. As indicated above, and explained below, embodiments of the present invention are capable of handing off a terminal from one point of connection to another, while reducing link-layer delay otherwise associated with such handoff. In this regard, by establishing a link-layer connection between the mobile node and the target agent via the anchor agent and a tunnel between the anchor agent and the target agent, link-layer delay due to link-layer and IP-layer signaling can be reduced, if not eliminated, while handoff of the mobile node is completed. Then, after registering the mobile node with the target agent, data packets can pass between the mobile node and the correspondent node through the target agent, across the physical-layer connection and the link-layer connection, and independent of the anchor agent and the tunnel between the target agent and the anchor agent. As such, the system, mobile node, agent and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of mobile node and system that would benefit from embodiments of the present invention;

FIG. 2 is a schematic block diagram of an entity capable of operating as a mobile node, home agent, foreign agent and/or correspondent node, in accordance with embodiments of the present invention;

FIG. 3 is a schematic block diagram of a mobile node, in accordance with one embodiment of the present invention;

FIG. 4 illustrates a multi-layer protocol stack of a node in accordance with one embodiment of the present invention where the protocol stack comprises the OSI model including seven layers;

FIG. 5 illustrates a comparison of the OSI functionality of a node in accordance with an embodiment of the present invention, and the generic OSI model;

FIG. 6 is a control flow diagram illustrating communication between various entities performing a method of handing off a mobile node from a current, anchor foreign agent to a new, target foreign agent, in accordance with one embodiment of the present invention; and

FIG. 7 is a control flow diagram illustrating communication between various entities performing a method of handing off a mobile node from a current, anchor foreign agent to a new, target foreign agent, in accordance with another embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

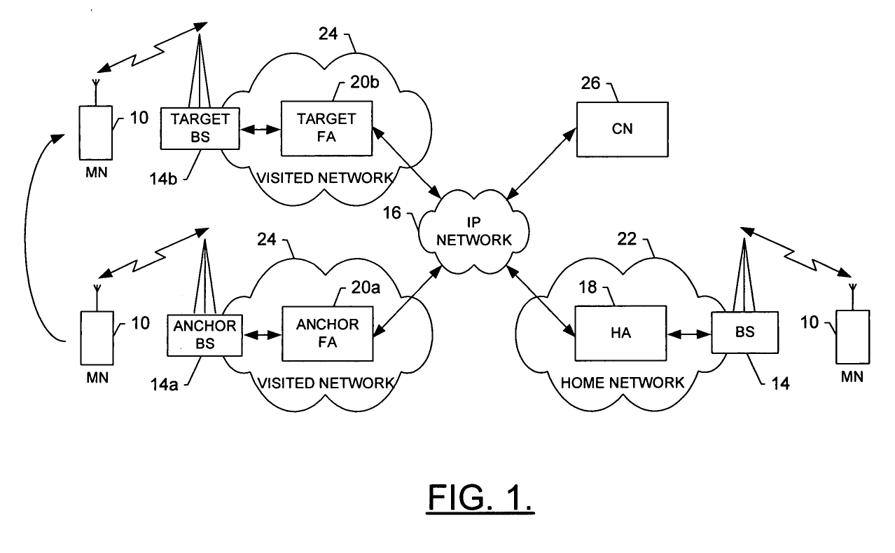

Referring to FIG. 1, an illustration of one type of system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, the system can include a mobile node (MN) 10 capable of transmitting signals to and for receiving signals from base sites or base stations (BS) 14, two of which are shown in FIG. 1 (shown and described below as including an anchor BS 14a that provides fast network access and a target BS 14b that provides slow network access during fast handoff). The base station is a part of one or more cellular or mobile networks that each include elements required to operate the network, such as a mobile switching center (MSC) (not shown). As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also control the forwarding of messages for the terminal to and from a messaging center.

The MN 10 can also be coupled to a data network. For example, the BS 14 can be coupled to a data network, such as a local area network (LAN), a metropolitan area network (MAN), and/or a wide area network (WAN). In one typical embodiment, the BS is coupled to a gateway, which is coupled to the data network, such as an Internet Protocol (IP) network 16. The gateway can comprise any of a number of different entities capable of providing network connectivity between the MN and other nodes directly or indirectly coupled to the data network. As will be appreciated, the gateway can be described in any of a number of different manners, such as a home agent (HA) 18, foreign agent (FA) 20 (shown and described below as including an anchor FA 20a and a target FA 20b during fast handoff), packet data serving node (PDSN), access router (AR) or the like. In this regard, as defined in the MIP (MIP) protocol, a HA comprises a router within a home network 22 of the MN. The HA is capable of tunneling data for delivery to the MN when the MN is away from home, and can maintain current location information for the MN. A FA, on the other hand, comprises router within a visited network 24 of the MN. The FA provides routing services to the MN while the MN is registered with the visited network. In operation, the FA detunnels data from the HA, and delivers the data to the MN. Then, for data sent from a MN registered with the visited network, the FA can serve as a default router.

The other nodes coupled to the MN 10 via the IP network 16 can comprise any of a number of different devices, systems or the like capable of communicating with the MN in accordance with embodiments of the present invention. The other nodes can comprise, for example, personal computers, server computers or the like. Additionally or alternatively, for example, one or more CNs can comprise, other MNs, such as mobile telephones, portable digital assistants (PDAs), pagers, laptop computers, or the like. As described herein, a node capable of communicating with the MN via the IP network is referred to as a correspondent node (CN) 26, one of which is shown in FIG. 1.

Although not every element of every possible network is shown and described herein, it should be appreciated that the MN 10 can be coupled to one or more of any of a number of different networks. In this regard, mobile network(s) can be capable of supporting communication in accordance with any one or more of a number of second-generation (2G), 2.5G and/or third-generation (3G) mobile communication protocols or the like. Additionally or alternatively, mobile network(s) can be capable of supporting communication in accordance with any of a number of different wireless networking techniques, including WLAN techniques such as IEEE 802.11, WiMAX techniques such as IEEE 802.16 or the like. Further, for example, the mobile network(s) can be capable of supporting communication in accordance with any one or more of a number of different digital broadcast networks, such as Digital Video Broadcasting (DVB) networks including DVB-T (DVB-Terrestrial) and/or DVB-H (DVB-Handheld), Integrated Services Digital Broadcasting (ISDB) networks including ISDB-T (ISDB-Terrestrial), or the like.

More particularly, for example, the MN 10 can be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Further, one or more of the network(s) can be capable of supporting enhanced 3G wireless communication protocols such as 1XEV-DO (TIA/EIA/IS-856) and 1XEV-DV.

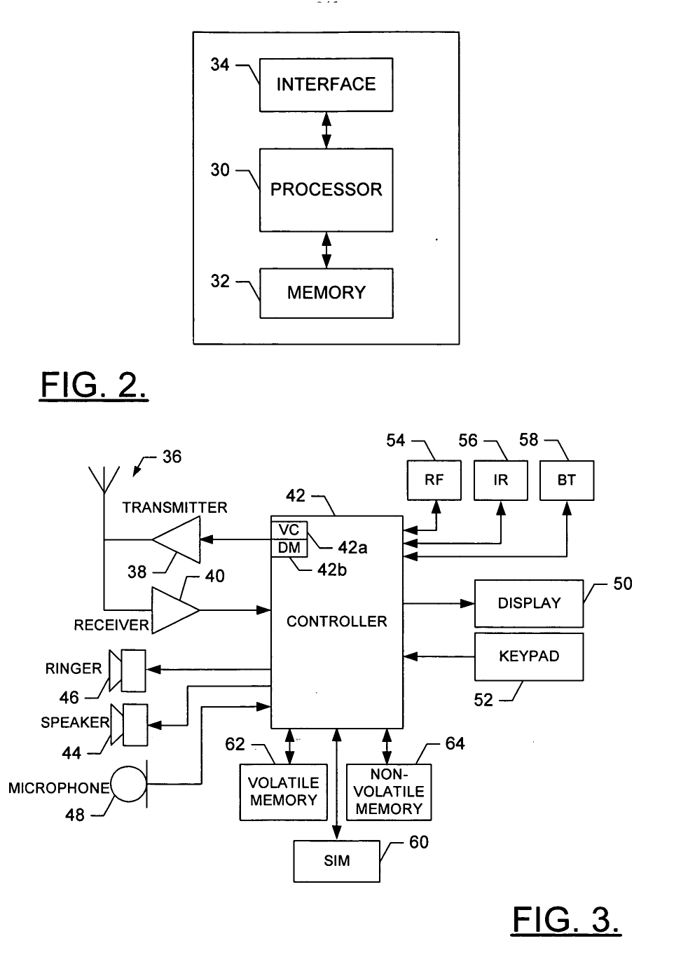

Referring now to FIG. 2, a block diagram of an entity capable of operating as a MN 10, HA 18, FA 20 and/or CN 26 is shown in accordance with one embodiment of the present invention. Although shown as separate entities, in some embodiments, one or more entities may support one or more of a MN, HA, FA and/or CN, logically separated but co-located within the entit(ies). For example, a single entity may support a logically separate, but co-located, HA and CN. Also, for example, a single entity may support a logically separate, but co-located FA and CN.

As shown, the entity capable of operating as a MN 10, HA 18, FA 20 and/or CN 26 can generally include a processor 30 connected to a memory 32. The processor can also be connected to at least one interface 34 or other means for transmitting and/or receiving data, content or the like. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

Reference is now made to FIG. 3, which illustrates one type of MN 10 that would benefit from embodiments of the present invention. It should be understood, however, that the MN illustrated and hereinafter described is merely illustrative of one type of MN that would benefit from the present invention and, therefore, should not be taken to limit the scope of the present invention. While several embodiments of the MN are illustrated and will be hereinafter described for purposes of example, other types of MNs, such as portable digital assistants (PDAs), pagers, laptop computers and other types of electronic systems, can readily employ the present invention.

As shown, in addition to an antenna 36, the MN 10 can include a transmitter 38, receiver 40, and controller 42 or other processor that provides signals to and receives signals from the transmitter and receiver, respectively. These signals include signaling information in accordance with the air interface standard of the applicable cellular system, and also user speech and/or user generated data. In this regard, the MN can be capable of operating with one or more air interface standards, communication protocols, modulation types, and access types. More particularly, the MN can be capable of operating in accordance with any of a number of second generation (2G), 2.5G and/or third-generation (3G) communication protocols or the like. For example, the MN may be capable of operating in accordance with 2G wireless communication protocols IS-136 (TDMA), GSM and IS-95 (CDMA), 2.5G wireless communication protocols such as GPRS and/or Enhanced Data GSM Environment (EDGE), and/or 3G wireless communication protocols such as Universal Mobile Telephone System (UMTS) network employing Wideband Code Division Multiple Access (WCDMA) radio access technology. Also, for example, the MN can also be capable of operating in accordance with enhanced 3G wireless communication protocols such as 1XEV-DO (TIA/EIA/IS-856) and 1XEV-DV. Further, for example, the MN can be capable of operating in accordance with any of a number of different wireless networking techniques, including WLAN techniques such as IEEE 802.11, WiMAX techniques such as IEEE 802.16 or the like.

It is understood that the controller 42 includes the circuitry required for implementing the audio and logic functions of the MN 10. For example, the controller may be comprised of a digital signal processor device, a microprocessor device, and various analog-to-digital converters, digital-to-analog converters, and other support circuits. The control and signal processing functions of the MN are allocated between these devices according to their respective capabilities. The controller can additionally include an internal voice coder (VC) 42a, and may include an internal data modem (DM) 42b. Further, the controller may include the functionally to operate one or more software programs, which may be stored in memory (described below). For example, the controller may be capable of operating a connectivity program, such as a conventional Web browser. The connectivity program may then allow the MN to transmit and receive Web content, such as according to HTTP and/or the Wireless Application Protocol (WAP), for example.

The MN 10 also comprises a user interface including a conventional earphone or speaker 44, a ringer 46, a microphone 48, a display 50, and a user input interface, all of which are coupled to the controller 42. The user input interface, which allows the MN to receive data, can comprise any of a number of devices allowing the MN to receive data, such as a keypad 52, a touch display (not shown) or other input device. In embodiments including a keypad, the keypad includes the conventional numeric (0-9) and related keys (#, *), and other keys used for operating the MN. Although not shown, the MN can include a battery, such as a vibrating battery pack, for powering the various circuits that are required to operate the MN, as well as optionally providing mechanical vibration as a detectable output.

The MN 10 can also include one or more means for sharing and/or obtaining data. For example, the MN can include a short-range radio frequency (RF) transceiver or interrogator 54 so that data can be shared with and/or obtained from electronic devices in accordance with RF techniques. The MN can additionally, or alternatively, include other short-range transceivers, such as, for example an infrared (IR) transceiver 56, and/or a Bluetooth (BT) transceiver 58 operating using Bluetooth brand wireless technology developed by the Bluetooth Special Interest Group. The MN can therefore additionally or alternatively be capable of transmitting data to and/or receiving data from electronic devices in accordance with such techniques.

The MN 10 can further include memory, such as a subscriber identity module (SIM) 60, a removable user identity module (R-UIM) or the like, which typically stores information elements related to a mobile subscriber. In addition to the SIM, the MN can include other removable and/or fixed memory. In this regard, the MN can include volatile memory 62, such as volatile Random Access Memory (RAM) including a cache area for the temporary storage of data. The MN can also include other non-volatile memory 64, which can be embedded and/or may be removable. The non-volatile memory can additionally or alternatively comprise an EEPROM, flash memory or the like. The memories can store any of a number of software applications, instructions, pieces of information, and data, used by the MN to implement the functions of the MN. For example, the memories can store an identifier, such as an international mobile equipment identification (IMEI) code, international mobile subscriber identification (IMSI) code, mobile station integrated services digital network (MSISDN) code (mobile telephone number), Internet Protocol (IP) address, Session Initiation Protocol (SIP) address or the like, capable of uniquely identifying the MN.

As explained in the background section, MIP enables a MN 10 to move freely from one point of connection to another in various networks it visits along its route. In particular, the MIP protocol describes those actions that enable a MN to maintain connectivity during a handover from one access router to another access router. Briefly, MIP enables the mobile node to be identified by its home address, regardless of its current point of attachment to the IP network 16. When the MN is in a visiting network 24 away from the home network 22, it is also associated with a care-of-address, which provides information about the MN's current location. Typically, during a handoff between FAs 20 the care-of-address changes but the home address remains the same.

As also explained in the background section, a typical handover of the MN 10 requires link-layer and IP-layer signaling, during which the MN is unable to send or receive data packets. In many situations, such handoff delay may be unacceptable to support real-time, or otherwise delay sensitive network traffic. Thus, seamless mobility management techniques can be required for such services. In this regard, seamless mobility management can reduce or eliminate service interruption, packet loss and handoff delay, thus increasing the quality of service (QoS). And whereas seamless handoff can be achieved through fast handoff and context transfer, generic fast handoff mechanisms only reduce the IP-layer signaling delays and do not address the link-layer delays.

As explained in greater detail below, embodiments of the present invention are therefore capable of link-layer assisted fast handoff from one point of connection to another in various networks the MN 10 visits along its route. Embodiments of the present invention are capable of handing off a MN from one point of connection to another, while reducing link-layer delay otherwise associated with such handoff. More particularly, embodiments of the present invention are capable of reducing link-layer delay when a MN is handed off from a fast-access network to a slow-access network. For information on a technique for reducing link-layer delay when a MN is handed off from a slow-access network to another of the same or different type of slow-access network, see U.S. patent application Ser. No. ______, entitled: System and Associated Mobile Node, Foreign Agent and Method for Link-Layer assisted Mobile IP Fast Handoff filed Jun. 29, 2004, the contents of which are hereby incorporated by reference in its entirety.

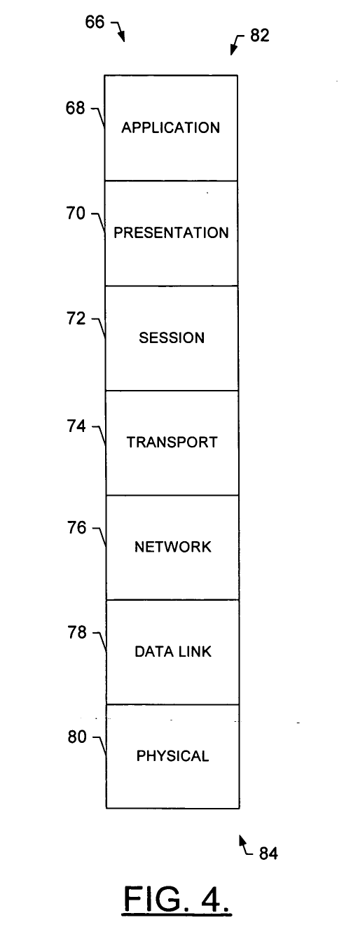

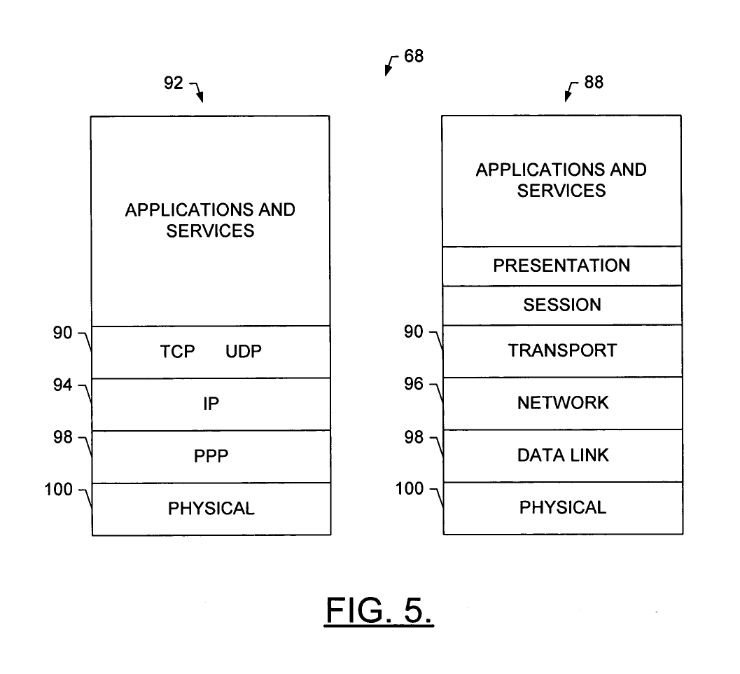

Before describing the method of link-layer fast handoff in accordance with various embodiments of the present invention, reference is made to FIGS. 4 which illustrate a protocol stack of a node (e.g., MN 10, CN 26, etc.) and a comparison of the protocol stack of the node in accordance with embodiments of the present invention, and the generic Open Systems Interconnection (OSI) model. In FIGS. 4 and 5, the protocol stack may be implemented in software, hardware, firmware or combinations of the same. More particularly, FIG. 4 illustrates the OSI model 66 which includes seven layers, including an application layer 68, presentation layer 70, session layer 72, transport layer 74, network layer 76, data link layer 78 and physical layer 80. The OSI model was developed by the International Organization for Standardization (ISO) and is described in ISO 7498, entitled: The OSI Reference Model, the contents of which are incorporated herein by reference in its entirety.

Each layer of the OSI model 66 performs a specific data communications task, a service to and for the layer that precedes it (e.g., the network layer 76 provides a service for the transport layer 74). The process can be likened to placing a letter in a series of envelopes before it is sent through the postal system. Each succeeding envelope adds another layer of processing or overhead information necessary to process the transaction. Together, all the envelopes help make sure the letter gets to the right address and that the message received is identical to the message sent. Once the entire package is received at its destination, the envelopes are opened one by one until the letter itself emerges exactly as written.

Actual data flow between two nodes (e.g., MN 10 and CN 26) is from top 82 to bottom 84 in the source node, across the communications line, and then from bottom 84 to top 82 in the destination node. Each time that user application data passes downward from one layer to the next layer in the same node more processing information is added. When that information is removed and processed by the peer layer in the other node, it causes various tasks (error correction, flow control, etc.) to be performed.

The ISO has specifically defined all seven layers, which are summarized below in the order in which the data actually flows as they leave the source node.

Layer 7, the application layer 68, provides for a user application to interface with the OSI application layer. And as indicated above, the OSI application layer can have a corresponding peer layer in another node communicating with the application layer.

Layer 6, the presentation layer 70, makes sure the user information is in a format (i.e., syntax or sequence of ones and zeros) the destination node can understand or interpret.

Layer 5, the session layer 72, provides synchronization control of data between the nodes (i.e., makes sure the bit configurations that pass through layer 5 at the source are the same as those that pass through layer 5 at the destination).

Layer 4, the transport layer 74, ensures that an end-to-end connection has been established between the two nodes and is often reliable (i.e., layer 4 at the destination confirms the request for a connection, so to speak, that it has received from layer 4 at the source node).

Layer 3, the network layer 76, provides routing and relaying of data through the network (among other things, at layer 3 on the outbound side an address gets placed on the envelope which is then read by layer 3 at the destination).

Layer 2, the data link layer 78, includes flow control of data as messages pass down through this layer in one node and up through the peer layer in the other node.

Layer 1, the physical interface layer 80, includes the ways in which data communications equipment is connected mechanically and electrically, and the means by which the data moves across those physical connections from layer 1 at the source node to layer 1 at the destination node.

FIG. 5 illustrates a comparison 86 of the OSI functionality of the MN 10 and/or CN 26 in accordance with embodiments of the present invention, and the generic OSI model. More particularly, FIG. 5 illustrates where the Internet Protocol (IP) network layer 94 fits in the OSI seven layer model 88. As shown, the transport layer 90 provides data connection services to applications and may contain mechanisms that guarantee that data is delivered error-free, without omissions and in sequence. The transport layer in the TCP/IP model 92 sends segments by passing them to the IP layer, which routes them to the destination. The transport layer accepts incoming segments from the IP layer, determines which application is the recipient, and passes the data to that application in the order in which it was sent.

Thus, the IP layer 94 performs network layer 96 functions and routes data between nodes (e.g., MN 10 and CN 26). Data may traverse a single link or may be relayed across several links in an IP network 16. Data is carried in units called datagrams, which include an IP header that contains layer 3 98 addressing information. Routers examine the destination address in the IP header in order to direct datagrams to their destinations. The IP layer is called connectionless because every datagram is routed independently and the IP layer does not guarantee reliable or in-sequence delivery of datagrams. The IP layer routes its traffic without caring which application-to-application interaction a particular datagram belongs to.

The Transmission Control Protocol (TCP) layer 90 provides a reliable data connection between devices using TCP/IP protocols. The TCP layer operates on top of the IP layer 94 that is used for packing the data to data packets, sometimes referred to as datagrams, and for transmitting the datagrams across the data link layer and underlying network via physical layer 100. The data link layer can operate in accordance with any of a number of different protocols, such as the Point-to-Point Protocol (PPP). As will be appreciated, the IP protocol doesn't contain any flow control or retransmission mechanisms. That is why the TCP layer 90 is typically used on top of the IP layer 94. In this regard, TCP protocols provide acknowledgments for detecting lost data packets.

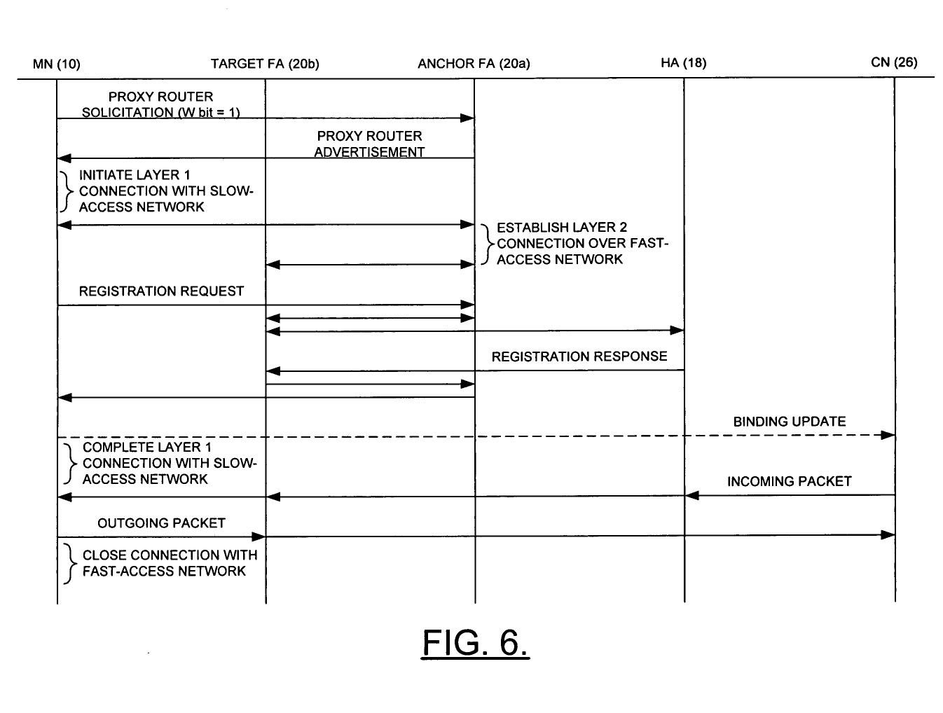

Reference is now made to FIG. 6, which illustrates a control flow diagram of a method of handing off a MN 10 from a current, anchor FA 20a to a new, target FA 20b, such as during a communication session between the MN and a CN 26. As explained herein, the MN is handed off from an anchor FA to a target FA. It should be understood, however, that the MN can be equally handed off from an anchor HA 18 to a target FA, or alternatively from an anchor FA to a target HA, without departing from the spirit and scope of the present invention. Also, as explained below, the method of FIG. 6 is particularly applicable to handing off a MN from a fast-access network to a slow-access network. In this regard, the method of FIG. 6 will be explained in conjunction with handing off a MN from an anchor AR (i.e., anchor FA) in a WLAN network to a target PDSN (i.e., target FA) in a CDMA network. It should be understood, however, that the method of FIG. 6 can be equally applicable to handing off a MN from any of a number of other fast-access networks to any of a number of other slow-access networks, without departing from the spirit and scope of the present invention.

As shown in FIG. 6, a method of handing off a MN 10 from an anchor FA 20a in a fast-access network to a target FA 20b in a slow-access network in accordance with one embodiment of the present invention includes the MN requesting, from the anchor FA, the IP address of the target FA. More particularly, the MN can monitor the signal strength of both the fast-access network and the slow-access network. In this regard, the link-layer (i.e., layer 2) termination point for the MN and the target FA in the slow-access network co-exist in the same node. As the MN monitors the signal strengths, when the MN recognizes that the signal strength of the fast-access network decreases below a threshold signal strength, the MN can request the IP address of the anchor FA.

The MN 10 can request the IP address of the target FA 20b in any of a number of different manners. For example, the MN can request the target FA IP address by sending a proxy router solicitation to the anchor FA 20a, such as proxy router solicitation being defined in IETF (Internet Engineering Task Force) Request for Comments document RFC 3220, entitled: IP Mobility Support for IPv4 (January 2002), the contents of which are hereby incorporated by reference in its entirety. As will be appreciated, the MN may not know the IP address or the link-layer (i.e., layer 2) address of the target FA, although the proxy router solicitation technique of RFC 3220 may require the link-layer address. But since fast-access networks such as WLAN generally have a geographically fixed coverage area, the anchor FA can be preconfigured with the IP address of the target FA to which the MN should be handed off. In such an instance, the anchor FA and the target FA can have a pre-established security association.

Thus, to allow the anchor FA 20a to properly interpret the proxy router solicitation, the MN 10 can modify the proxy router solicitation, such as by setting a “W” bit of the proxy router solicitation, the “W” bit otherwise being reserved. Upon receipt of the modified proxy router solicitation, then, the anchor FA can send the MN information regarding the target FA 20b such that the MN can thereafter register with the target FA. In one embodiment, for example, the anchor FA can send the MN a proxy router advertisement message which is defined in IETF Internet Draft draft-ietf-mobileip-fast-mipv6-08.txt, entitled: Fast Handovers for MIPv6 (Oct. 10, 2003), the contents of which are hereby incorporated by reference in its entirety. As defined by the IETF Internet Draft, the proxy router advertisement message is based upon the agent advertisement message, defined in IETF Request for Comments document RFC 3220, entitled: IP Mobility Support for IPv4 (January 2002), the contents of which are also hereby incorporated by reference in its entirety. In this regard, the proxy router advertisement message can include a mobility agent advertisement extension having a care-of address (i.e., IP address) of the target FA.

After sending the modified proxy router solicitation, the MN 10 can initiate a physical-layer (i.e., layer 1) connection with the slow-access network, or more particularly with a target BS 14b in the slow-access network, the target BS being capable of thereafter serving the MN. As the physical-layer connection is initiated, the MN can generate or otherwise be assigned a unique connection ID. In the case of handoff from a WLAN network to a CDMA network, for example, the MN can initiate a new physical-layer connection with the target BS in accordance with the CDMA service option (SO) 33. In setting up a new physical-layer connection, the MN can utilize a new service reference identifier (SR_ID) associated with the new physical-layer connection. Also in setting up the new physical-layer connection, a target PCF (which can be integrated with the target BS) can establish a R-P connection with the target PDSN (i.e., target FA 20b) with the new SR_ID. For more information on SO 33, see Telecommunications Industry Association/Electronic Industries Alliance specification TIA/EIA/IS-707-A-3, entitled Data Services Option Standard for Spread Spectrum Systems—Addendum 3: cdma2000 High Speed Packet Data Device Option 33 (February 2003).

Also, as or after the physical-layer connection is initiated between the MN 10 and the target BS 14b, the anchor FA 20a and target FA 20b can establish a tunnel therebetween. More particularly, during initiation of the physical-layer connection, a tunnel can be established between the target FA and the anchor FA through signaling between the respective BS and the relevant network components. In handing off from a WLAN network to a CDMA network, for example, a tunnel can be established between the target PDSN (i.e., target FA) and the anchor AR (i.e., anchor FA).

Then, during setup of the physical-layer connection initiated between the MN 10 and the target BS 14b, the MN 10 can establish a link-layer (i.e., layer 2) connection with the slow-access network, or more particularly the target FA 20b in the slow-access network, such as after the unique connection ID (e.g., SR_ID) is generated. Instead of establishing the link-layer connection after establishing the physical-layer connection and across the physical-layer connection initiated between the MN and the target BS, however, the link-layer connection can advantageously be established with the target FA via the anchor FA 20a and the tunnel between the anchor FA and the target FA. As the fast link with the anchor FA has a shorter round trip time (RTT) than the slow access interface, establishment of the link-layer connection can require a shorter period of time than establishing the same link-layer connection across the previously initiated physical-layer connection.

In handing off from a WLAN network to a CDMA network, for example, after the MN 10 sends an origination message for SO 33 to the target BS 14b, the MN can begin PPP negotiation with the target PDSN (i.e., target FA 20a) through the WLAN/AR (i.e., 20 anchor FA 20a). In this regard, PPP data frames can be sent from the MN to the anchor AR, and tunneled through the anchor AR to the target PDSN. As the PPP negotiation can occur across the fast link while the SO 33 setup occurs across a slow link the PPP negotiation with the target PDSN can, in various instances, be completed before the SO 33 setup. Thus, the target PDSN can be capable of performing the PPP negotiation without the underlying physical-layer connection being established. In this regard, an extension can be added for link control protocol (LCP) to thereby notify the target PDSN of the SR_ID (i.e., unique connection ID) generated during initiation of the physical-layer connection between the MN and the target BS. The extension can include any of a number of different pieces of information, but in one exemplar embodiment, includes the mobile identification (MIN) and/or the electronic serial number (ESN) of the MN, as well as the SR_ID.

After establishing the link-layer (i.e., layer 2) connection with the slow-access network, or more particularly the target FA 20b, the MN 10 can perform MIP registration with the target FA based on the information (e.g., care-of address) received from the anchor FA 20a in the proxy router advertisement. In this regard, the MN can send a MIP registration request to the target FA. As will be appreciated, however, as the link-layer connection may be established across a fast link before the physical-layer connection across a slow link, the MIP registration may occur via the anchor FA and the tunnel between the anchor FA and the target FA 20b. Thus, the anchor FA may first receive the MIP registration request, and thereafter route the MIP registration request to the target FA to initiate the MN registering with the target FA.

After receiving the MIP registration request, the target FA 20b can process the registration request and relay the request to the HA 18 of the MN 10 to thereby inform the HA of the registration request, and information regarding the target FA including the care-of address of the target FA. When the various entities operate in accordance with IPv4 (IP version 4), the HA can then add the necessary information, including the target FA care-of address to its routing table for the MN, approve the request, and send a registration response back to the MN via the target FA. In contrast, when the entities operate in accordance with IPv6 (IP version 6), the HA can approve the request, and send a registration response back to the MN, which can then send a binding update to the HA or the CN 26. The HA can then add the necessary information to its routing table for the MN. For more information on such MIP registration processes, see IETF RFC 3220 and Internet Draft draft-ietf-mobileip-fast-mipv6-08.txt.

As will be appreciated, by registering the MN 10 with the target FA 20, future incoming packets to the MN can be routed to the target FA 20b and then to the MN, as opposed to the anchor FA 20a and then the MN. Before the physical layer (i.e., layer 1) connection is completed between the MN and the slow-access network, however, future packets incoming to the MN and outgoing from the MN may still be routed via the target FA and the tunnel between the target FA and the anchor FA. Then, after the physical layer (i.e., layer 1) connection is completed between the MN and the slow-access network, when incoming data packets from the CN 26 reach the target FA, the target FA can activate link-layer (i.e., layer 2) context information previously negotiated during establishment of the link-layer connection. For example, when handing off from a WLAN network to a CDMA network, the context information can be activated by matching the MIN/ESN and SR_ID. Then, after activating the link-layer context information, the target FA can forward the incoming data packet to the MN in accordance with the link-layer context information (e.g., over the R-P interface). Thus, data packets need not pass from the target FA, through the tunnel between the target FA and anchor FA, and from the anchor FA to the MN, as before.

Similarly, after the physical layer (i.e., layer 1) connection is completed between the MN and the slow-access network, outgoing data packets from the MN 10 can be forwarded from the target FA 20b in the slow-access network to the CN 26 without being tunneled to the anchor FA 20a in the fast-access network. And since the fast-access network is no longer required to pass data packets between the MN and the CN, the MN can close the fast link IP session with the anchor FA. Likewise, as the tunnel between the target FA and the anchor FA is no longer required to pass data packets between the MN and the CN, the target FA and/or anchor FA can tear down or otherwise close the tunnel.

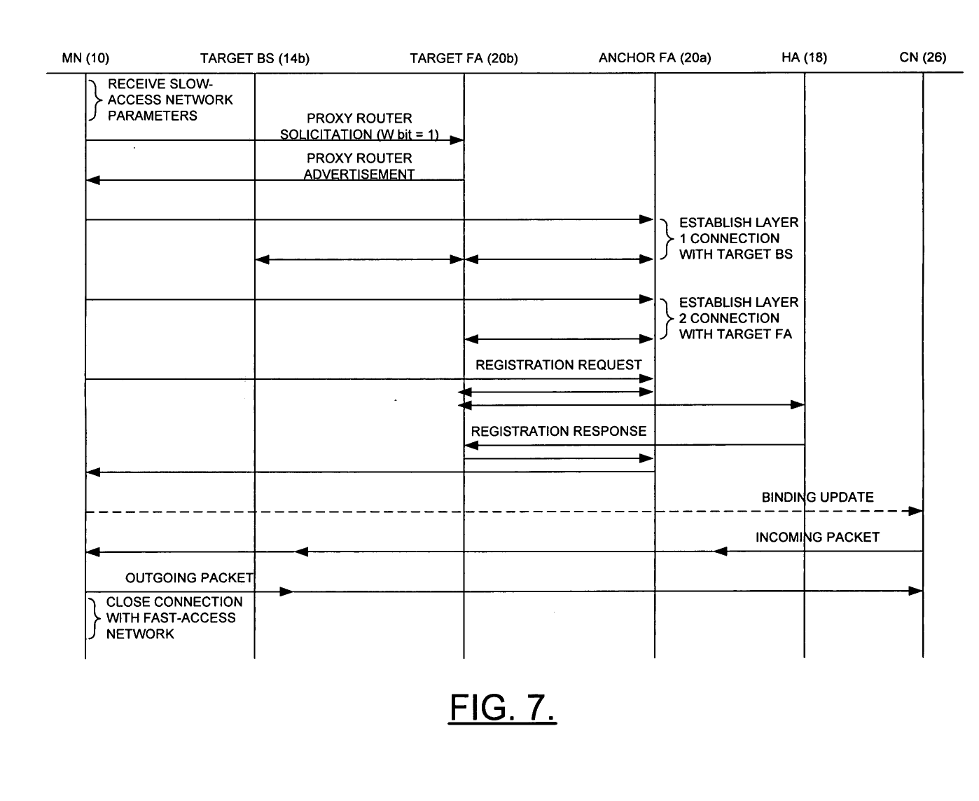

Reference is now made to FIG. 7, which illustrates a control flow diagram of an alternative method of handing off a MN 10 from a current, anchor FA 20a to a new, target FA 20b, such as during a communication session between the MN and a CN 26. As explained below, the method of FIG. 7 is particularly applicable to handing off a MN from a fast-access network to a slow-access network. In this regard, the method of FIG. 7 will be explained in conjunction with handing off a MN from an anchor AR (i.e., anchor FA) in a WLAN network to a target PDSN (i.e., target FA), in a CDMA network. It should be understood, however, that the method of FIG. 7 can be equally applicable to handing off a MN from any of a number of other fast-access networks to any of a number of other slow-access networks, without departing from the spirit and scope of the present invention.

As shown in FIG. 7, a method of handing off a MN 10 from an anchor FA 20a to a target FA 20b in accordance with another embodiment of the present invention includes storing network parameters for the slow-access network before or as the MN establishes a connection with the fast-access network. In the context of handing off from a WLAN network to a CDMA network, for example, when the MN is powered up or otherwise initialized, the MN can lock on to the CDMA channel and the WLAN channel, such as via a CDMA radio frequency (RF) driver and a WLAN RF driver of the MN. In this regard, after locking on to the CDMA channel, the MN can receive various CDMA network parameters from the system parameters and extended system parameters message on the paging or forward broadcast channel of the CDMA network. For example, the MN can receive CDMA network parameters such as the access network ID (ANID), pseudo-noise (PN) offset, system ID (SID), network ID (NID) and packet zone ID (PZID) of the target BS 14b in the slow-access network (the ANID identifying the target PCF which can be integrated with the target BS), the target BS being capable of serving the MN.

After receiving the slow-access network parameters, then, the MN 10 can store the slow-access network parameters, such as in memory (e.g., non-volatile memory 64) of the MN. Also, as or after receiving the slow-access parameters, the MN can determine to establish a connection with the anchor FA 20b in the fast-access network. In the context of handing off from a WLAN network to a CDMA network, for example, after locking on to the CDMA channel and the WLAN channel, the MN can determine to establish a connection with an anchor AR (i.e., anchor FA) in the WLAN network, and thereafter establish such a connection. In this regard, after locking on to the WLAN channel, the MN can determine if the WLAN signal strength is above a threshold, and if so, establish a connection with the anchor AR. Otherwise, the MN can establish a connection with the target PDSN (i.e., target FA 20a).

At some point after establishing a connection with the anchor FA 20a in the fast-access network, the MN 10 can request, from the anchor FA, the IP address of the target FA 20b. More particularly, for example, the MN can monitor the signal strength of both the fast-access network and the slow-access network. Then, similar to before, when the MN recognizes that the signal strength of the fast-access network decreases below a threshold signal strength, the MN can request the IP address of the target FA. As before, the MN can request the IP address of the target FA in any of a number of different manners, such as by sending a proxy router solicitation to the anchor FA 20a. In such an instance, also as before, the anchor FA can be preconfigured with the IP address of the target FA to which the MN should be handed off, and the MN 10 can modify the proxy router solicitation, such as by setting a “W” bit of the proxy router solicitation.

Upon receipt of the modified proxy router solicitation, then, the anchor FA 20a can send the MN 10 information regarding the target FA 20b such that the MN can thereafter register with the target FA. In a manner similar to before, for example, the anchor FA can send the MN a proxy router advertisement message that can include a mobility agent advertisement extension having a care-of address (i.e., IP address) of the target FA.

After receiving information regarding the target FA 20b, the MN 10 can defer registering with the target FA, instead instructing the anchor FA 20a to setup a tunnel between the anchor FA and the target FA, where the anchor FA and the target FA typically have a pre-established security association. In instructing the anchor FA to setup a tunnel between the anchor FA and the target FA, the MN can send the anchor FA the slow-access network parameters previously received and stored by the MN. More particularly with respect to handing off from a WLAN network to a CDMA network, for example, the MN send a setup_CDMA_L1_req message to the anchor AR (i.e., anchor FA), where the setup_CDMA_L1_req message includes the ANID, PN offset, SID, NID and/or the PZID of the target BS 14b.

In response to receiving the instruction from the MN 10, the anchor FA 20a can establish a tunnel with the target FA 20b. Further, with the slow-access network parameters received from the MN, the anchor FA can establish an interface with the target BS 14b. In the case of handing off from a WLAN network to a CDMA network, for example, the anchor AR (i.e., anchor FA) can initiate a generic routing encapsulation (GRE) tunnel between the anchor AR and the target PDSN (i.e., target FA). As the tunnel is established, then, the anchor AR can send a tunnel registration request to the target PDSN, the message including the PN offset, SID, NID and PZID of the CDMA BS (i.e., target BS).

In response to receiving the tunnel registration request, the target PDSN (i.e., target FA 20b) can begin the tunnel setup process and establish a new A10/A11 interface with the target PCF (associated or otherwise integrated with the target BS 14b) based upon one or more of the slow-access network parameters (e.g., ANID, PN offset, SID, etc.). Further, the target PCF can establish a new A8/A9 interface with the target BS based upon one or more of the slow-access network parameters. As will be appreciated by those skilled in the art, the A9 interface can provide for signaling to initiate establishment and release of an A8 connection for packet data services. Similar to the A9 interface, the A11 interface can provide signaling to request establishment, refresh, update and release of an A10 connection for packet data services. The A8 interface can provide the user traffic path between the target BS and the PCF. And the A10 interface can provide the user traffic path between the target PCF and the target PDSN. For more information on such a process of establishing a new packet data service instance, see generally 3GPP2 specification 3GPP2 A.S0013-A v2.0.1, and particularly section 3.17.4.1.

After the tunnel is established between the anchor FA 20a and the target FA 20b, and the interface is established between the anchor FA and the target BS 14b, the MN 10 can establish a physical-layer (i.e., layer 1) connection with the target BS. Instead of establishing the physical-layer connection directly with the target BS, however, the MN can establish the physical-layer connection with the target BS via the fast link with the anchor FA, the tunnel between the anchor FA and the target FA, and the interface with the target BS. In handing off the MN from a WLAN network to a CDMA network, for example, the MN can initiate a new physical-layer connection with the target BS in accordance with the CDMA SO 33, and over the WLAN link. In this regard, the MN can send a proxy origination message to the WLAN AR (i.e., anchor FA), where the proxy origination message can include a number of the same elements as a CDMA layer 3 (i.e., network layer) origination message.

Upon receipt of the proxy origination message at the anchor AR (i.e., anchor FA 20a), the anchor AR can forward the message through the tunnel to the target PDSN (i.e., target FA 20b), which forwards the message to the target BS 14b. In this regard, the target PDSN can forward the message through the previously established A8/A9 interface to the target PCF, and from the target PCF to the target BS through the A10/A11 interface. The target BS can then respond to the proxy origination message with a channel assignment message, which can include a number of the same elements included in a CDMA channel assignment message. The target BS can forward the channel assignment message back to the target PCF, and from the target PCF to the target PDSN. The target PDSN can then forward the channel assignment message back to the anchor AR through the tunnel, with the anchor AR thereafter forwarding the channel assignment message back to the MN 10 via the fast link between the MN and the anchor AR.

After establishing the physical-layer (i.e., layer 1) connection with the target BS 14b, the MN 10 can establish a link-layer (i.e., layer 2) connection with the target FA 20b. Similar to before, instead of establishing the link-layer connection directly with the target FA, however, the MN can establish the link-layer connection with the target FA via the fast link with the anchor FA 20a, and the tunnel between the anchor FA and the target FA. With respect to handing off the MN from a WLAN network to a CDMA network, for example, after receiving the channel assignment message, the MN can begin PPP negotiation with the target PDSN (i.e., target FA) through the anchor AR (i.e., anchor FA). In this regard, the MN can send a setup_CDMA_L2_req message to the anchor AR, the setup_CDMA_L2_req message including a number of PPP parameters.

In response to receiving the setup_CDMA_L2_req message, the anchor AR (i.e., anchor FA 20a) can forward the message, including the PPP parameters, to the target PDSN (i.e., target FA 20b) through a tunnel between the anchor AR and the target PDSN. Although the tunnel through which the setup_CDMA_L2_req is forwarded can be the same tunnel previously established, but in a more typical embodiment, the anchor AR establishes another tunnel with the target PDSN and forwards the setup_CDMA_L2_req message through the new tunnel since the setup_CDMA_L2_req message is related to a task different from the previous task including messages forwarded through the tunnel. Irrespective of whether the anchor AR establishes another tunnel, however, in response to receiving the setup_CDMA_L2_req message, including the PPP parameters, the target PDSN can initialize a PPP connection.

Then, after establishing the link-layer (i.e., layer 2) connection with the slow-access network, or more particularly the target FA 20b, the MN 10 can perform MIP registration with the target FA based on the information (e.g., care-of address) received from the anchor FA 20a in the proxy router advertisement, such as in the same manner described above. More particularly, the MN can send a MIP registration request to the target FA via the anchor FA 20a and a tunnel between the anchor FA and the target FA. Thus, the anchor FA may first receive the MIP registration request, and thereafter route the MIP registration request to the target FA to initiate the MN registering with the target FA. Similar to before, the tunnel through which the MIP registration request is forwarded can be any of the previously established tunnels. In a more typical embodiment, however, the anchor FA establishes an additional tunnel with the target FA and forwards the MIP registration request through the new tunnel since the MIP registration request is related to yet another, different task.

Again, by registering the MN 10 with the target FA 20, future incoming packets to the MN can be routed to the target FA 20b and then to the MN, as opposed to the anchor FA 20a and then the MN. In this regard, when incoming data packets from the CN 26 reach the target FA, the target FA can activate link-layer (i.e., layer 2) context information previously negotiated during establishment of the link-layer connection. Then, after activating the link-layer context information, the target FA can forward the incoming data packet to the MN in accordance with the link-layer context information. Thus, data packets need not pass from the target FA, through the tunnel between the target FA and anchor FA, and from the anchor FA to the MN, as before.

Similarly, outgoing data packets from the MN 10 can be forwarded from the target FA 20b in the slow-access network to the CN 26 without being tunneled to the anchor FA 20a in the fast-access network. And since the fast-access network is no longer required to pass data packets between the MN and the CN, the MN can close the fast link IP session with the anchor FA. Likewise, as the tunnels between the target FA and the anchor FA is no longer required to pass data packets between the MN and the CN, the target FA and/or anchor FA can tear down or otherwise close the tunnels.

According to one aspect of the present invention, all or a portion of the system of the present invention, such all or portions of the MN 10, anchor FA 20a and target FA 20b, generally operate under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 6 and 7 are control flow diagrams of methods, systems and program products according to the invention. It will be understood that each block or step of the control flow diagrams, and combinations of blocks in the control flow diagrams, can be implemented by computer program instructions. These computer program instructions may be loaded onto a computer or other programmable apparatus to produce a machine, such that the instructions which execute on the computer or other programmable apparatus create means for implementing the functions specified in the control flow diagrams block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the control flow diagrams block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the control flow diagrams block(s) or step(s).

Accordingly, blocks or steps of the control flow diagrams support combinations of means for performing the specified functions, combinations of steps for performing the specified functions and program instruction means for performing the specified functions. It will also be understood that each block or step of the control flow diagrams, and combinations of blocks or steps in the control flow diagrams, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for handing off a mobile node, the system comprising:
a mobile node capable of communicating with an anchor agent, and capable of being handed off from the anchor agent;
a target agent capable of establishing a tunnel between the target agent and the anchor agent,
wherein the mobile node is capable of establishing a physical-layer connection between the mobile node and a target base station associated with the target agent,
wherein the mobile node is capable of establishing a link-layer connection between the mobile node and the target agent via the anchor agent and the tunnel between the anchor agent and the target agent, and
wherein the mobile node is capable of registering with the target agent to thereby bind the mobile node to the target agent such that at least one data packet sent between the mobile node and a correspondent node passes through the target agent, across the link-layer connection and the physical-layer connection, and independent of the anchor agent and the tunnel.

2. A system according to claim 1, wherein the mobile node is capable of establishing the link-layer connection before completing establishment of the physical-layer connection.

3. A system according to claim 2, wherein the mobile node is capable of the physical-layer connection independent of the anchor agent and the tunnel.

4. A system according to claim 1, wherein the mobile node is capable of establishing the physical-layer connection via the anchor agent, the tunnel between the anchor agent and the target agent, and an interface with the target base station.

5. A system according to claim 4, wherein the mobile node is capable of receiving at least one network parameter for a network including the target agent, and thereafter establishing a connection with the anchor agent to thereby communicate with the anchor agent, and wherein the mobile node is capable of establishing a physical-layer connection via an interface previously established based upon the at least one network parameter.

6. A system according to claim 1 further comprising:
a correspondent node capable of communicating with the mobile node,
wherein the target agent is capable of receiving an incoming data packet from the correspondent node independent of the anchor agent, the incoming data packet being received after the mobile node registers with the target agent, wherein the target agent is capable of activating a link-layer context negotiated during establishment of the link-layer connection, and thereafter forwarding the data packet to the mobile node from the target agent.

7. A system according to claim 1 further comprising:
a correspondent node capable of communicating with the mobile node, wherein the target agent is capable of receiving an outgoing data packet from the
mobile node, the outgoing data packet being received after the mobile node registers with the target agent, and wherein the target agent is capable of forwarding the data packet to the correspondent node independent of the anchor agent and the tunnel, and in accordance with a link-layer context, the link-layer context having been negotiated during establishment of the link-layer connection and activated by the target agent.

8. A mobile node comprising:
a processor capable of communicating with an anchor agent, and capable of being handed off from the anchor agent to a target agent, wherein the processor is capable of establishing a physical-layer connection between the mobile node and a target base station associated with the target agent, wherein the processor is capable of establishing a link-layer connection between the mobile node and the target agent via the anchor agent and a tunnel previously established between the anchor agent and the target agent, and wherein the processor is capable of registering the mobile node with the target agent to thereby bind the mobile node to the target agent such that at least one data packet sent between the mobile node and a correspondent node passes through the target agent, across the link-layer connection and the physical-layer connection, and independent of the anchor agent and the tunnel.

9. A mobile node according to claim 8, wherein the processor is capable of establishing the link-layer connection before completing establishment of the physical-layer connection.

10. A mobile node according to claim 9, wherein the processor is capable of establishing the physical-layer connection independent of the anchor agent and the tunnel.

11. A mobile node according to claim 8, wherein the processor is capable of establishing the physical-layer connection via the anchor agent, a tunnel previously established between the anchor agent and the target agent, and an interface with the target base station.

12. A mobile node according to claim 11, wherein the processor is capable of receiving at least one network parameter for a network including the target agent, and thereafter establishing a connection with the anchor agent to thereby communicate with the anchor agent, and wherein the processor is capable of establishing the physical-layer connection via an interface previously established based upon the at least one network parameter.

13. A mobile node according to claim 8, wherein the processor is capable of registering the mobile node such that the target agent is capable of receiving an incoming data packet from the correspondent node independent of the anchor agent, activating a link-layer context at the target agent, the link-layer context being negotiated during establishment of the link-layer connection, and thereafter forwarding the data packet to the mobile node.

14. A mobile node according to claim 8, wherein the processor is capable of registering the mobile node such that the target agent is capable of receiving an outgoing data packet from the mobile node, and thereafter forwarding the data packet to the correspondent node from the target agent independent of the anchor agent and the tunnel, and in accordance with a link-layer context at the target agent, the link-layer context having been negotiated during establishment of the link-layer connection and activated at the target agent.

15. An agent for use in handing off a mobile node from an anchor agent, the agent comprising:
a processor capable of establishing a tunnel between the agent and the anchor agent such that the mobile node is capable of establishing a physical-layer connection between the mobile node and a target base station associated with the agent, and establishing a link-layer connection between the mobile node and the agent via the anchor agent and the tunnel, wherein the processor is also capable of registering the mobile node to thereby bind the mobile node to the agent such that at least one data packet sent between the mobile node and a correspondent node passes through the agent, across the link-layer connection and the physical-layer connection, and independent of the anchor agent and the tunnel.

16. An agent according to claim 15, wherein the processor capable of establishing a tunnel between the agent and the anchor agent such that the mobile node is capable of establishing the link-layer connection before completing establishment of the physical-layer connection.

17. An agent according to claim 16, wherein the processor capable of establishing a tunnel between the agent and the anchor agent such that the mobile node is capable of establishing the physical-layer connection independent of the anchor agent and the tunnel.

18. An agent according to claim 15, wherein the processor capable of establishing a tunnel between the agent and the anchor agent such that the mobile node is capable of establishing the physical-layer connection via the anchor agent, the tunnel between the anchor agent and the agent, and an interface with the target base station.

19. An agent according to claim 15, wherein the processor is further capable of receiving an incoming data packet from the correspondent node independent of the anchor agent, the incoming data packet being received after registering the mobile node, and wherein the processor is capable of activating a link-layer context negotiated during establishment of the link-layer connection, and thereafter forwarding the data packet to the mobile node.

20. An agent according to claim 15, wherein the processor is further capable of receiving an outgoing data packet from the mobile node, the outgoing data packet being received after registering the mobile node, and wherein the processor is capable of forwarding the data packet to the correspondent node independent of the anchor agent and the tunnel, and in accordance with a link-layer context at the agent, the link-layer context having been negotiated during establishment of the link-layer connection and activated by the agent.

21. A method of handing off a mobile node from an anchor agent in communication with the mobile mode to a target agent, the method comprising:
establishing a physical-layer connection between the mobile node and a target base station associated with the target agent;
establishing a link-layer connection between the mobile node and the target agent via the anchor agent and a tunnel previously established between the anchor agent and the target agent; and
registering the mobile node with the target agent to thereby bind the mobile node to the target agent such that at least one data packet sent between the mobile node and a correspondent node passes through the target agent, across the link-layer connection and the physical-layer connection, and independent of the anchor agent and the tunnel.

22. A method according to claim 21, wherein establishing a link-layer connection comprises establishing a link-layer connection before completing establishment of the physical-layer connection.

23. A method according to claim 2, wherein establishing a physical-layer connection comprises establishing a physical-layer connection independent of the anchor agent and the tunnel.

24. A method according to claim 21, wherein establishing a physical-layer connection comprises establishing a physical-layer connection via the anchor agent, a tunnel previously established between the anchor agent and the target agent, and an interface with the target base station.

25. A method according to claim 24 further comprising:
receiving at least one network parameter for a network including the target agent; and thereafter
establishing a connection between the mobile node and the anchor agent to thereby permit the mobile node to communicate with the anchor agent, and
wherein establishing a physical-layer connection via an interface with the target base station comprises establishing a physical-layer connection via an interface previously established based upon the at least one network parameter.

26. A method according to claim 21 further comprising:
receiving an incoming data packet at the target agent from the correspondent node independent of the anchor agent, the incoming data packet being received after registering the mobile node with the target agent;
activating a link-layer context at the target agent, the link-layer context being negotiated during establishment of the link-layer connection; and
forwarding the data packet to the mobile node from the target agent.

27. A method according to claim 21 further comprising:
receiving an outgoing data packet at the target agent from the mobile node, the outgoing data packet being received after registering the mobile node with the target agent; and
forwarding the data packet to the correspondent node from the target agent independent of the anchor agent and the tunnel, and in accordance with a link-layer context at the target agent, the link-layer context having been negotiated during establishment of the link-layer connection and activated at the target agent.
